(19) United States
(12) Patent Application Publication
(10) Pub. No.: US 2014/0095291 A1
(43) Pub. Date: Apr. 3, 2014

(54) MEDIA DISTRIBUTION SYSTEM

(71) Applicant: FRAMEBLAST LIMITED, London (GB)

(72) Inventors: Aaron Dey, London (GB); Steven Allen, London (GB)

(73) Assignee: FRAMEBLAST LIMITED, London (GB)

(21) Appl. No.: 13/705,070

(22) Filed: Dec. 4, 2012

(30) Foreign Application Priority Data
Sep. 28, 2012 (GB) 1217407.4

(51) Int. Cl. G06Q 30/02

(52) U.S. Cl. CPC G06Q 30/0239; G06Q 30/0269
USPC 705/14.39

(57) ABSTRACT

A media distribution system (100) includes one or more databases (210) coupled via a communication network (200) to users (260). The system (100) provides for a subset of the users (260) to upload video content (250) for distribution via the system (100) to other users (260), wherein:
(a) the system (100) includes a reviewing arrangement (270) for receiving the uploaded video content (250) provided to the system (100) and for generating corresponding recommendations (280) which determine an extent to which the video content (250) is disseminated through the system (100) to other users (260): and
(b) the system (100) includes a reward arrangement for rewarding users who have uploaded the video content (250) to the system (100) as a function of the recommendations (280) and an extent of distribution of the video content (250).

### FIELD OF THE INVENTION

The present invention relates to media distribution systems, for example to media distribution system which are operable to distribute short video clips. Moreover, the present invention concerns methods of distributing media, for example to methods of distributing media including short video clips. Furthermore, the present invention relates to software products stored on machine-readable data storage carrier, wherein the software products are executable upon computing hardware for implementing aforesaid methods.

### BACKGROUND OF THE INVENTION

During the past thirty years, personal computers (PC) have evolved to an extent that they can be coupled up to communication networks, for example to the Internet, which has enabled content, for example video content, to be shared by users throughout such communication networks. In parallel with this evolution of personal computers, mobile telephones and tablet computers have evolved to be equipped with cameras, together with more computing power and data memory, such that these mobile telephones and tablet computers can be used by a given user to share still pictures and video content with other mobile telephone or tablet computer users. Many contemporary mobile telephones and tablet computers are Internet-enabled, via cellular operator networks or WiFi connections, such that they can be employed to surf the Internet.

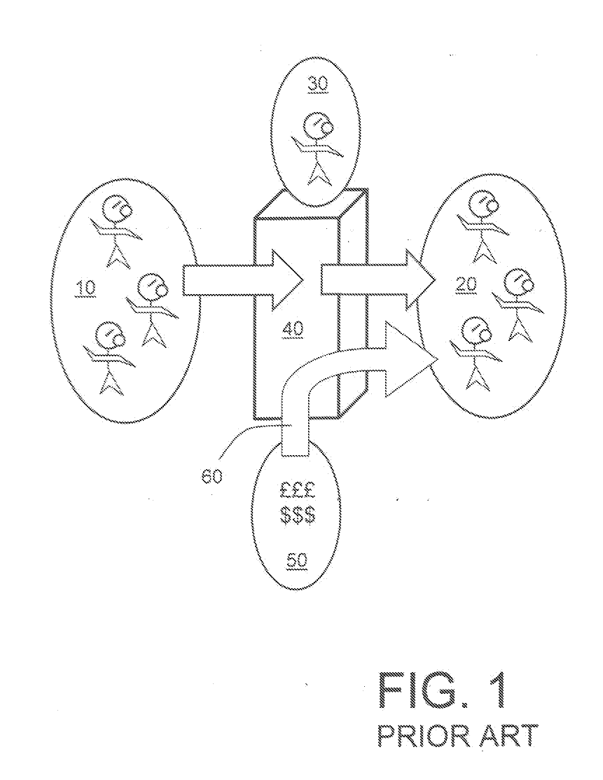

Internet platforms such as Facebook and YouTube have enabled given users 10 which are amateur video producers to upload their video content for viewing by other users 20; “Facebook” and “YouTube” are registered trade marks. Referring to FIG. 1, operators 30 of such platforms 40 have generated income 50 by including advertisements 60 on their platforms 40 which are presented to the other users 20 when they search and view video content of their preference. However, such platforms 40 are not adapted to reward financially the given users 10 who expend effort to generate video content and hence rely on the voluntary efforts of such given users 10 to generate video content. Moreover, many users of aforesaid platforms 40 find advertisements obtrusive and deleterious to enjoyment of video content.

### SUMMARY OF THE INVENTION

The present invention seeks to provide a media distribution system, also known as a media distribution platform, which is operable to reward more effectively given users who generate video content.

Moreover, the present invention seeks to provide a method of distributing media in a form of video content, which rewards more effectively given users who generate video content.

According to a first aspect of the present invention, there is provided a media distribution system as defined in appended claim 1: there is provided a media distribution system including one or more databases coupled via a communication network to users, wherein the system provides for a subset of the users to upload video content for distribution via the system to other users, wherein:
(a) the system includes a reviewing arrangement for receiving the uploaded video content provided to the system and for generating corresponding recommendations which determine an extent to which the video content is disseminated through the system to other users; and
(b) the system includes a reward arrangement for rewarding users who have uploaded the video content to the system as a function of the recommendations and an extent of distribution of the video content.

The invention is of advantage in that the system is more rewarding for given users of the system to employ when distributing their video content,

Optionally, the media distribution system is implemented such that the reviewing arrangement includes users who belong to at least one special interest group accommodated by the system, and the system includes an arrangement for directing the uploaded video content to the at least special interest group based on subject matter included in the uploaded video content.

Optionally, the media distribution system is implemented such that the system is operable to generate advertisement content for presenting to a given user, wherein the advertisement content comprises an advertiser's video content combined with video content provided by the given user, or by at least one special interest group to which the given user belongs, wherein the advertiser's video content includes at least one video template into which the video content provided by the given user, or by at least one special interest group to which the given user belongs, is inserted, thereby personalizing the advertisement content to the given user.

Optionally, the media distribution system is implemented such that the system includes an arrangement for monitoring a dissemination of the video content to users and aggregating distribution results for generating distribution analyses. More optionally, the media distribution system is implemented such that the arrangement of monitoring the dissemination is operable to monitor dissemination of composite music cups and video cups and providing analysis data indicative of association of the music cups with video clips elected by users of the system.

According to a second aspect of the invention, there is provided a method of operating a media distribution system including one or more databases coupled via a communication network to users, wherein the system provides for a subset of the users to upload video content for distribution via the system to other users, wherein the method includes:
(a) using a reviewing arrangement of the system for receiving the uploaded video content provided to the system and for generating corresponding recommendations which determine an extent to which the video content is disseminated through the system to other users; and
(b) using a reward arrangement of the system for rewarding users who have uploaded the video content to the system as a function of the recommendations and an extent of distribution of the video content.

Optionally, the method includes arranging for the reviewing arrangement to include users who belong to at least one special interest group accommodated by the system, and arranging for the system to include an arrangement for directing the uploaded video content to the at least special interest group based on subject matter included in the uploaded video content.

Optionally, the method includes arranging for the system to generate advertisement content for presenting to a given user, wherein the advertisement content comprises an advertiser's video content combined with video content provided by the given user, or by at least one special interest group to which the given user belongs, wherein the advertiser's video content includes at least one video template into which the video content provided by the given user, or by at least one special interest group to which the given user belongs, is inserted, thereby personalizing the advertisement content to the given user.

Optionally, the method includes arranging for the system to include an arrangement for monitoring a dissemination of the video content to users and aggregating distribution results for generating distribution analyses. More optionally, the arrangement of monitoring the dissemination is operable to monitor dissemination of composite music clips and video clips and providing analysis data indicative of association of the music clips with video clips elected by users of the system.

According to a third aspect of the invention, there is provided a software product recorded on machine-readable data storage media, whereinthe software product is executable upon computing hardware for executing a method pursuant to the second aspect of the invention.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

FIG. 1 is an illustration of a conventional platform for distributing video content;

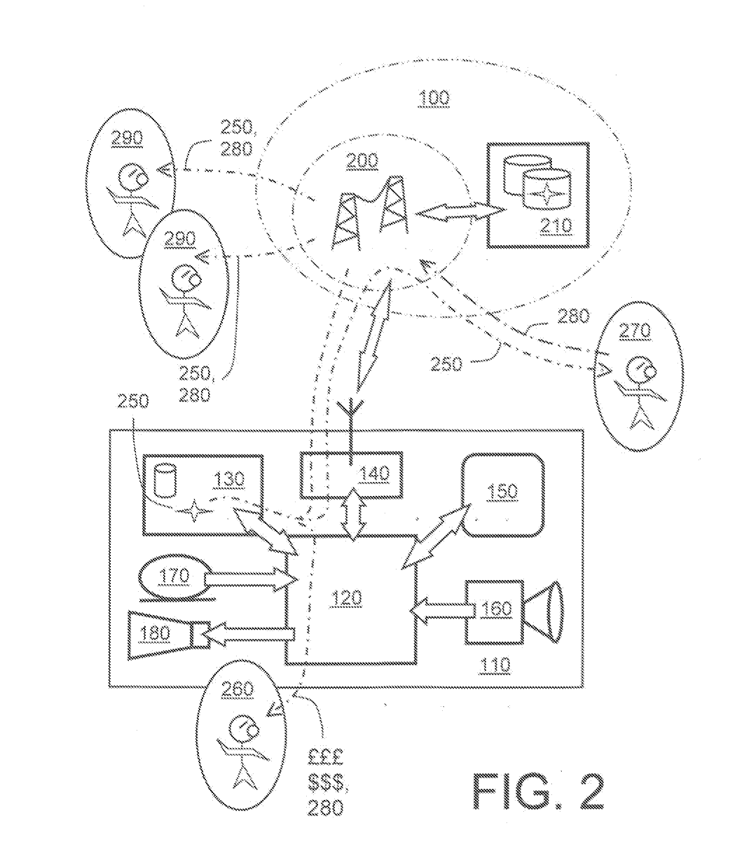

FIG. 2 is an illustration of a media distribution system pursuant to the present invention;

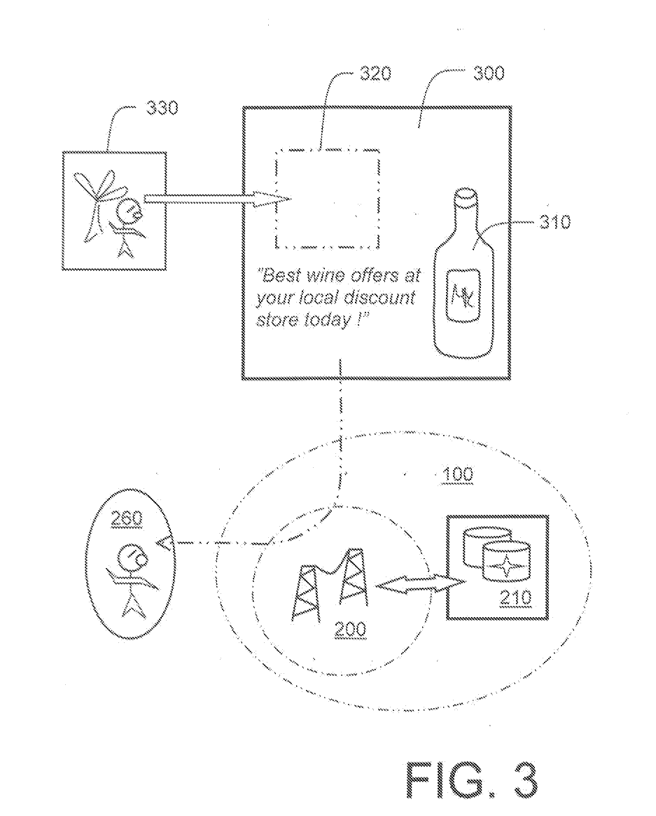

FIG. 3 is an illustration of advertisement content generation pursuant to the present invention; and

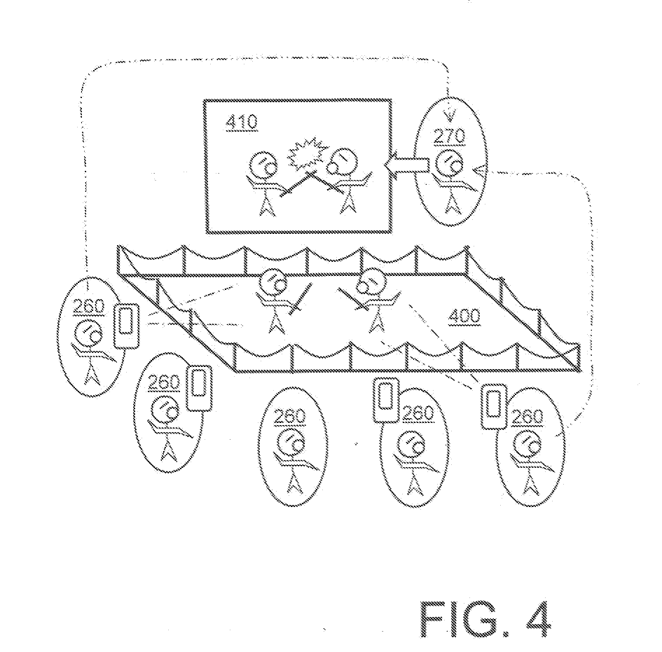

FIG. 4 is an illustration of an application of the present invention in association with a social event, for example a sports event.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

In overview, the present invention is concerned with media distribution system which operates in a different manner to contemporary Facebook and YouTube as represented in FIG. 1. Referring to FIG. 2, the media distribution system 100 is especially well adapted for handling short video clips, for example substantially 3 second duration video clips generated from mobile wireless devices 110, for example from contemporary smart telephones, tablet computers, wireless communication enabled digital cameras and video recorders. The devices 110 each include computing hardware 120 coupled to data memory 130, to a wireless interface 140, to a graphical user interface 150, to a video camera 160, and to a microphone 170 and loudspeaker 180. The media distribution system 100 includes a communication network 200, such a cellular operator network or WiFi Internet connection, for receiving video content from the devices 110 and also one or more databases 210 for storing users video content which has been uploaded from their devices 110. However, the system 100 is optionally operable to receive video content from other sources, for example from contemporary digital cameras whose video content is uploaded, for example via a personal computer (PC), through the Internet to the one or more databases 210. The media distribution system 100 operates in several ways which is radically different to the platform 40 of FIG. 1, namely:
(a) the system 100 communicates the video content 250 provided from one or more of the devices 110 of one or more given users 260 to a group of reviewing users 270 who assess the communicated video content 250 and make a recommendation 280, for example a rating of the video content 250, a decision YES/NO whether or not the video content should be used for a given purpose and so forth. Optionally, the group of reviewing users 270 is implemented, at least in part, automatically using computing machine-intelligence, for example by way of neural networks implemented in computing hardware and software, and/or by rule rule-based analysis, for example employing one or more stages of Fourier analysis of sound signals, and spatial Fourier analysis of images in video content;
(b) the system 100 rewards the given users 260 of the one or more devices 110 which have provided the video content 250 to the system 100 with bonus points and/or financial payment depending upon the recommendation 280 from (a) and/or a distribution to other users 290 that the video content 250 receives based upon the recommendation 280;
(c) the system 100 establishes special interest groups of users who have a mutually common interests, for example steam trains, classical pipe organs, stamp collecting, antiques, cycling, golf and so forth; each user is optionally a member of several different interest groups; optionally, the group of reviewing users 270 in (a) are users in a special interest group reviewing video content whose subject matter pertains to the special interest group; and
(d) the system 100 is operable to provide the given users 260 with video advertisements which at least one of: include as an integral part thereof one or more video clips generated by a given user 260 to which the advertisements are presented, include as an integral part thereof one or more video clips generated by one or more users who are in a similar special interest group to a given user 260 to which the advertisements are presented. The system 100 is thus operable to generate video advertisements as illustrated in FIG. 3 including a template video advertisement 300 including an identification 310 of a product or service to be sold and a template 320, wherein the template video advertisement 300 includes the template 320 into which one or more user video clips 330 can be inserted, wherein the template 320 is a subfield of the template video advertisement 300 and the template video advertisement 300 and the one or more video clips are played substantially concurrently to the given users 260.

The present invention is capable of bringing many benefits in comparison to contemporary aforesaid known platforms such as Facebook and You Tube. Advertisers who elect to advertise via the system 100 will have much greater impact with their advertisement because including one or more video clips of the given user 260 into advertisements presented to the given user 260 will achieve more sympathy and attention form the given user 260, and thus improved advertising impact. Similarly, video clips generated by other users in a similar special interest group to that of the given user 260 are more likely to be of interest to the given user 260, hence resulting in the advertisements being more sympathetically received by the given user 260, hence causing the given user 260 to be more positively inclined towards the products and/or services presented to the given user 260 in the advertisements.

The system 100 is also capable of functioning as a “sales market” for video clips. This enables each user of a device 110 to become their own film director and receive benefit, for example financial benefit, if their videos receive a good recommendation and are subsequently employed by other users of the system 100. This enables poorer people in poorer parts of the World to have an alternative source of income, as well as educating other parts of the World, for example the rich First World, about conditions in poorer parts of the World by way of short video clips, namely an aim promoted by UNESCO and other international relief agencies. Moreover, news gathering agencies are able to offer payment for video clips provided via the system 100 from various parts of the World from where they are desirous to gather news, for example from natural disaster areas and from war afflicted areas.

An example use of the system 100 is in a social event as depicted in FIG. 4, for example a sports event. A sports event occurs in an arena 400, for example in a football pitch, in a tennis pitch, in a boxing ring, or similar. The given users 260 are present in a spectator or viewer area surrounding at least a part of a periphery of the arena 400. During executing of the sports event, the given users 260 are spectators and employ their mobile wireless devices 110 to take short video clips of the event. The short video clips are communicated by wireless to a group of reviewing users 270 who are responsible for the event and who rapidly review substantially in real time the short video clips to determine which would be most suitable to display in substantially real time on a large display screen 410 mounted adjacently to the arena 400. The short video clips of given users 260 that are presented on the large display screen 410, for example a projection display screen, are rewarded by the group of reviewing users 270 providing the given users 260 with a form of bonus, for example free tickets to other sports events or financial payment. Such an arrangement is capable of increasing interest in sport events attended by the given users 260 and also provides the reviewing users 270 with a collection of short video clips which can be employed for generating video content for communication via international communication to other parts of the World for generating sports televising revenues. Although a sports event is described in the foregoing, the system 100 is susceptible to being employed at music concert events, ceremonial events and so forth.

Optionally, the group of reviewing users 270 is implemented, at least in part, automatically using computing machine-intelligence, for example by way of neural networks implemented in computing hardware and software, and/or by rule rule-based analysis, for example employing one or more stages of Fourier analysis of sound signals, and spatial Fourier analysis of images in video content.

The system 100 is also capable of extracting aggregate data from the flow of short video clips communicated via the system 100, for example data pertaining to specialist interest groups. This aggregated data, for example trend analysis data, maintains the confidentiality of individual given users 260, but provides useful insight into dissemination of information. For example, when users of the system 100 are able to combine sound clips and video clips together to generate composite video content for dissemination, where copyright owners of the sound clips have permitted such use of their sound clips, the system 100 is capable by monitoring dissemination of the composite video content to determine the following;
(i) a popularity of a given sound clip, for example a song or instrumental music piece; and
(ii) a video context in which users consider the given sound clip to be most suitable.

Such information is potentially useful to popular music bands that are desirous to release their latest music productions in a manner which will generate most sales and will also assist to increase an awareness and profile of the popular music bands. The system 100 is able to offer such an investigative aggregation service to popular music bands and similar in return for payment.

It will be appreciated that the system 100 is capable of providing novel features which render it more beneficial to users in comparison to contemporary known content distribution platforms 40 such as YouTube and similar.

In another embodiment, the system 100 allows for a given user 260 to utilise his/her wireless device 110 to contribute content on-the-go or pre-recorded content by recording landscapes, locational information, or environmental trends via short video clips captured using his/her wireless device 110, for exampleusing a cellular phone or tablet computer to record, edit and distribute content in a spoke-and-hub approach.

Although reference is made to “short video clips”, for example video clips having a playing duration in a range of 1 to 10 seconds, more optionally substantially 3 seconds, it will be appreciated that the present invention is mutatis mutandis also relevant for the distribution of still pictures.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A media distribution system (100) including one or more databases (210) coupled via a communication network (200) to users (260), wherein the system (100) provides for a subset of the users (260) to upload video content (250) for distribution via the system (100) to other users (260), wherein:
(a) the system (100) includes a reviewing arrangement (270) for receiving the uploaded video content (250) provided to the system (100) and for generating corresponding recommendations (280) which determine an extent to which the video content (250) is disseminated through the system (100) to other users (260); and
(b) the system (100) includes a reward arrangement for rewarding users who have uploaded the video content (250) to the system (100) as a function of the recommendations (280) and an extent of distribution of the video content (250).

2. A media distribution system (100) as claimed in claim 1, wherein the reviewing arrangement (270) includes users (260) who belong to at least one special interest group accommodated by the system (100), and the system (100) includes an arrangement for directing the uploaded video content (250) to the at least special interest group based on subject matter included in the uploaded video content (250).

3. A media distribution system (100) as claimed in claim 1, wherein the system (100) is operable to generate advertisement content for presenting to a given user (260), wherein the advertisement content comprises an advertisers video content combined with video content provided by the given user (260), or by at least one special interest group to which the given user (260) belongs, wherein the advertiser's video content includes at least one video template into which the video content provided by the given user (260), or by at least one special interest group to which the given user (260) belongs, is inserted, thereby personalizing the advertisement content to the given user (260).

4. A media distribution system (100) as claimed in claim 1, wherein the system (100) includes an arrangement for monitoring a dissemination of the video content (250) to users (260) and aggregating distribution results for generating distribution analyses.

5. A media distribution system (100) as claimed in claim 4, wherein the arrangement of monitoring the dissemination is operable to monitor dissemination of composite music clips and video clips and providing analysis data indicative of association of the music clips with video clips elected by users (260) of the system (100).

6. A method of operating a media distribution system (100) including one or more databases (210) coupled via a communication network (200) to users (260), wherein the system (100) provides for a subset of the users (260) to upload video content (250) for distribution via the system (100) to other users (260), wherein the method includes:
(a) using a reviewing arrangement (270) of the system (100) for receiving the uploaded video content (250) provided to the system (100) and for generating corresponding recommendations (280) which determine an extent to which the video content (250) is disseminated through the system (100) to other users (260); and
(b) using a reward arrangement of the system (100) for rewarding users who have uploaded the video content (250) to the system (100) as a function of the recommendations (280) and an extent of distribution of the video content (250).

7. A method as claimed in claim 6, wherein the method includes arranging for the reviewing arrangement (270) to include users (260) who belong to at least one special interest group accommodated by the system (100), and arranging for the system (100) to include an arrangement for directing the uploaded video content (250) to the at least special interest group based on subject matter included in the uploaded video content (250).

8. A method as claimed in claim 6, wherein the method includes arranging for the system (100) to generate advertisement content for presenting to a given user (260), wherein the advertisement content comprises an advertiser's video content combined with video content provided by the given user (260), or by at least one special interest group to which the given user (260) belongs, wherein the advertiser's video content includes at least one video template into which the video content provided by the given user (260), or by at least one special interest group to which the given user (260) belongs, is inserted, thereby personalizing the advertisement content to the given user (260).

9. A method as claimed in any one of claims 6, wherein the method includes arranging for the system (100) to include an arrangement for monitoring a dissemination of the video content (250) to users (260) and aggregating distribution results for generating distribution analyses.

10. A method as claimed in claim 9, wherein the arrangement of monitoring the dissemination is operable to monitor dissemination of composite music clips and video clips and providing analysis data indicative of association of the music clips with video clips elected by users (260) of the system (100).

11. A software product recorded on machine-readable data storage media, wherein the software product is executable upon computing hardware (120, 210) for executing a method as claimed in any one of claims 6 to 10.
